(19) United States
(12) Patent Application Publication
(10) Pub. No.: US 2024/0196227 A1
(43) Pub. Date: Jun. 13, 2024

(54) AZIMUTH PLANNING FOR SMALL CELL SITE LOCATIONS WITHIN A CELLULAR NETWORK

(71) Applicant: RAKUTEN SYMPHONY SINGAPORE PTE. LTD., Singapore (SG)

(72) Inventors: Sudeep JAIN, Indore (IN); Durgesh RATHORE, Indore (IN); Shanu KORE, Indore (IN); Keshav SHARMA, Indore (IN)

(73) Assignee: RAKUTEN SYMPHONY SINGAPORE PTE. LTD., Singapore (SG)

(21) Appl. No.: 17/798,728

(22) PCT Filed: Jun. 15, 2022
(86) PCT No.: PCT/US2022/033521

§ 371 Date: Aug. 10, 2022

(51) Int. Cl. H04W 16/22; H04W 24/02; H04W 28/02; H04W 64/00

(52) U.S. Cl. CPC H04W 16/225; H04W 24/02; H04W 28/0226; H04W 64/003

(57) ABSTRACT

A system and method of determining one or more azimuths for identified cell site locations within a cellular network. The system and method can include receiving a list of one or more first cells with respect to a network and selecting from the list one or more first cells that are geographically oriented towards a second cell. In addition, the method can include arranging the selected one or more first cells based on their network congestion. Further, the method can include calculating a first azimuth between the second cell and at least one of the arranged one or more first cells, and determining that at least one of the one or more first cells is within a first predefined range of the first azimuth.

### BACKGROUND

### Technical Field

Apparatuses and methods consistent with example embodiments of the present disclosure relate to suggesting an azimuth for identified small cell site locations for deployment within a cellular network.

### Background

This section is intended to introduce the reader to aspects of art that may be related to various aspects of the present disclosure described herein, which are described and/or claimed below. This discussion is believed to be helpful in providing the reader with background information to facilitate a better understanding of the various aspects of the present disclosure described herein. Accordingly, it should be understood that these statements are to be read in this light, and not as admissions of prior art.

Cellular networks generally require a significant amount of bandwidth during peak times and a lower amount of bandwidth during other times. Network congestion can occur when a network node or link carries more data than it can handle, which reduces the quality of service. The effect of this congestion and lower bandwidth can include queueing delay, packet loss, or blocking new connections, among others. Deploying dedicated high-speed links, such as fiber, or highspeed microwave to every base station/macro-cell or adding additional macro-cells, in order to improve bandwidth, which can be costly and inefficient. To counter this, cellular networks can typically employ a small cell network in addition to their existing macro-layer network or macrocells to improve network availability, coverage, quality, resilience, and throughput, particularly with respect to “5G” networks. Such small cells can be used to offload traffic from the macrocells, or from the macro layers within the network. Generally, small cells are low-powered radio access nodes employed by wireless carriers to expand the density of existing wireless network, such as that of macro cells or base stations. These small cells can operate within a licensed or unlicensed spectrum, and can generally include femtocells, picocells, and microcells, among others. In addition, such small cells can be installed in various indoor and outdoor locations, such as on buildings, street posts, poles, facades, and on ceilings within indoor spaces, among other places.

Currently, if a small cell cite location is identified for deployment, there is no effective and efficient method of suggesting one or more azimuths for all of the identified small cell site locations such that the maximum number of highly utilized cells can be properly offloaded. Hence, what is needed is a method and system that can efficiently and accurately suggests the best suited azimuths for identified small cell site locations and further provides a visual representation of such small cell sites on a map.

### BRIEF SUMMARY

According to embodiments, systems and methods are provided that can efficiently and accurately effective and efficient method of suggesting one or more azimuths for identified small cell site locations such that the maximum number of highly utilized cells can be properly offloaded. According to embodiments, the small cell (“SC”) site azimuth planning (“SCAP”) systems and methods of the disclosure described herein can propose the best suited azimuth of new small cell sectors that improve capacity deficits in the macro cell layer based on the building heights, AMSL heights, and highly utilized cells (“HUC” or “HUCs”). In particular, the SCAP system and method of the disclosure described herein can suggest azimuths for small cell site locations that present the least cost and the highest performance in terms of traffic absorption and capacity provisions, such that highly utilized cells can be effectively offloaded. Here, an algorithm of the SCAP system and method can run periodically and provide information on suggested azimuths, which helps a radio frequency (“RF”) optimization team to reduce network congestion. Further, improving network congestion via the SCAP system and method of the disclosure described herein can result in increased customer satisfaction and lower customer churn rate, among other advantages.

According to embodiments, the SCAP system and method of the disclosure described herein can efficiently and effectively report the results of identified small cell sites and their suggested azimuths to a user within a graphical user interface (“GUI”) portal (such as within a table), and also within a graphical map of the small cell site locations. According to embodiments, the GUI portal of the disclosure described herein can display and identify on the map, based on certain geographical regions, the small cell site locations, structures, poles, outdoor spaces, or buildings, among others, with respect to a particular carrier or network which can be viewed from various zoom levels, such as from 100 km to 500 km, among others. In addition, the SCAP system and method of the disclosure described herein can support multiple vendors or wireless carrier or network providers.

According to embodiments, a method of determining one or more azimuths for identified cell site locations within a cellular network is disclosed. The method can include receiving a list of one or more first cells with respect to a network; selecting from the list one or more first cells that are geographically oriented towards a second cell; arranging the selected one or more first cells based on their network congestion; calculating a first azimuth between the second cell and at least one of the arranged one or more first cells; and determining that at least one of the one or more first cells is within a first predefined range of the first azimuth.

Further, the method can include upon determining that at least one of the one or more first cells is within a first predefined range of the first azimuth, calculating a second azimuth for the one or more first cells within the first predefined range with respect to the second cell. The method can further include determining if an average structure height is within a second predefined range of the first azimuth; determining if the average structure height is less than or equal to a structure height of the second cell; and upon determining that the average structure height is within the second predefined range of the first azimuth and the average structure height is less than or equal to a structure height of the second cell, suggesting a location for the second cell at the first azimuth.

In addition, the method can also include upon determining that at least one of the one or more first cells is not within a first predefined range of the first azimuth, determining if an average structure height is within a second predefined range of the first azimuth; determining if the average structure height is less than or equal to a structure height of the second cell; and upon determining that the average structure height is within the second predefined range of the first azimuth and the average structure height is less than or equal to a structure height of the second cell, suggesting a location for the second cell at the first azimuth.

The method may also include determining if an average structure height is within a second predefined range of the first azimuth; determining if the average structure height is less than or equal to a structure height of the second cell; and upon determining that the average structure height is within the second predefined range of the first azimuth and the average structure height is not less than or equal to a structure height of the second cell, modifying the first azimuth via a first step and determining if the average structure height is within the second predefined range of the modified first azimuth by the first step.

In addition, the method can include determining, after the determined modified first azimuth by the first step, if the average structure height is less than or equal to the structure height of the second cell; and upon determining that the average structure height is less than or equal to the structure height of the second cell, suggesting a location for the second cell at the modified first azimuth by the first step.

Further, the method can include determining, after the determined modified first azimuth, if the average structure height is less than or equal to the structure height of the second; and upon determining that the average structure height is not less than or equal to the structure height of the second cell, modifying the modified first azimuth by the first step via a second step and determining if the average structure height is within the second predefined range of the modified first azimuth by the second step.

The method can also include determining, after the determined modified first azimuth by the second step, if the average structure height is less than or equal to the structure height of the second cell; and upon determining that the average structure height is less than or equal to the structure height of the second cell, suggesting a location for the second cell at the modified first azimuth by the second step.

In addition, the method can include determining, after the determined modified first azimuth by the second step, if the average structure height is less than or equal to the structure height of the second cell; and upon determining that the average structure height is not less than or equal to the structure height of the second cell, providing a notification.

Further, the method can include determining if the second cell meets a first or second criteria with respect to the number of second cell locations; upon determining that the second cell meets the first or second criteria; and determining a second and third azimuth for the second cell. According to other embodiments, an apparatus for determining one or more azimuths for identified cell site locations within a cellular network is disclosed, including a memory storage storing computer-executable instructions; and a processor communicatively coupled to the memory storage, wherein the processor is configured to execute the computer-executable instructions and cause the apparatus to receive a list of one or more first cells with respect to a network; select from the list one or more first cells that are geographically oriented towards a second cell; arrange the selected one or more first cells based on their network congestion; calculate a first azimuth between the second cell and at least one of the arranged one or more first cells; and determine that at least one of the one or more first cells is within a first predefined range of the first azimuth.

Further, the computer-executable instructions, when executed by the processor, further cause the apparatus to upon determining that at least one of the one or more first cells is within a first predefined range of the first azimuth, calculate a second azimuth for the one or more first cells within the first predefined range with respect to the second cell.

In addition, the computer-executable instructions, when executed by the processor, further cause the apparatus to determine if an average structure height is within a second predefined range of the first azimuth; determine if the average structure height is less than or equal to a structure height of the second cell; and upon determining that the average structure height is within the second predefined range of the first azimuth and the average structure height is less than or equal to a structure height of the second cell, suggest a location for the second cell at the first azimuth.

Also, the computer-executable instructions, when executed by the processor, further cause the apparatus to upon determining that at least one of the one or more first cells is not within a first predefined range of the first azimuth, determine if an average structure height is within a second predefined range of the first azimuth; determine if the average structure height is less than or equal to a structure height of the second cell; and upon determining that the average structure height is within the second predefined range of the first azimuth and the average structure height is less than or equal to a structure height of the second cell, suggest a location for the second cell at the first azimuth.

In addition, the computer-executable instructions, when executed by the processor, further cause the apparatus to determine if an average structure height is within a second predefined range of the first azimuth; determine if the average structure height is less than or equal to a structure height of the second cell; and upon determining that the average structure height is within the second predefined range of the first azimuth and the average structure height is not less than or equal to a structure height of the second cell, modify the first azimuth via a first step and determining if the average structure height is within the second predefined range of the modified first azimuth by the first step.

Further, the computer-executable instructions, when executed by the processor, further cause the apparatus to determine, after the determined modified first azimuth by the first step, if the average structure height is less than or equal to the structure height of the second cell; and upon determining that the average structure height is less than or equal to the structure height of the second cell, suggest a location for the second cell at the modified first azimuth by the first step.

Also, the computer-executable instructions, when executed by the processor, further cause the apparatus to determine, after the determined modified first azimuth, if the average structure height is less than or equal to the structure height of the second; and upon determining that the average structure height is not less than or equal to the structure height of the second cell, modify the modified first azimuth by the first step via a second step and determining if the average structure height is within the second predefined range of the modified first azimuth by the second step.

In addition, the computer-executable instructions, when executed by the processor, further cause the apparatus to determine, after the determined modified first azimuth by the second step, if the average structure height is less than or equal to the structure height of the second cell; and upon determining that the average structure height is less than or equal to the structure height of the second cell, suggest a location for the second cell at the modified first azimuth by the second step.

Further, the computer-executable instructions, when executed by the processor, further cause the apparatus to determine, after the determined modified first azimuth by the second step, if the average structure height is less than or equal to the structure height of the second cell; and upon determining that the average structure height is not less than or equal to the structure height of the second cell, provide a notification.

According to other embodiments, a non-transitory computer-readable medium comprising computer-executable instructions for determining one or more azimuths for identified cell site locations within a cellular network by an apparatus, wherein the computer-executable instructions, when executed by at least one processor of the apparatus, cause the apparatus to receive a list of one or more first cells with respect to a network; select from the list one or more first cells that are geographically oriented towards a second cell; arrange the selected one or more first cells based on their network congestion; calculate a first azimuth between the second cell and at least one of the arranged one or more first cells; and determine that at least one of the one or more first cells is within a first predefined range of the first azimuth.

The above summary is not intended to describe each and every disclosed embodiment or every implementation of the disclosure. The Description that follows more particularly exemplifies the various illustrative embodiments.

### BRIEF DESCRIPTION OF THE DRAWINGS

The following description should be read with reference to the drawings, in which like elements in different drawings are numbered in like fashion. The drawings, which are not necessarily to scale, depict selected embodiments and are not intended to limit the scope of the disclosure. The disclosure may be more completely understood in consideration of the following detailed description of various embodiments in connection with the accompanying drawings, in which:

FIG. 1 illustrates a diagram of a general network architecture for the SCAP systems and methods of the disclosure described herein according to an embodiment;

FIG. 2 illustrates a diagram for various process components and modules of the SCAP systems and methods of the disclosure described herein according to an embodiment;

FIG. 3 illustrates a block diagram of a general process flow of the SCAP systems and methods of the disclosure described herein according to an embodiment;

FIG. 4 illustrates a block diagram of a general process flow of the SCAP systems and methods of the disclosure described herein according to an embodiment, which is a continuation of the process flow of FIG. 3;

FIG. 5 illustrates a block diagram of a general process flow of the SCAP systems and methods of the disclosure described herein according to an embodiment, which is a continuation of the process flow of FIG. 3; and

FIG. 6 illustrates a portal of a graphical user interface map of the SCAP systems and methods of the disclosure described herein.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “nonlimiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In one implementation of the disclosure described herein, a display page may include information residing in the computing device's memory, which may be transmitted from the computing device over a network to a central database center and vice versa. The information may be stored in memory at each of the computing device, a data storage resided at the edge of the network, or on the servers at the central database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (or any “smart phone”), a personal computer, tablet device, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including Bluetooth®, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also include a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile device graphical user interface, or digital presentation for a user. The portal may also be any graphical user interface for accessing various modules, components, features, options, and/or attributes of the disclosure described herein. For example, the portal can be a web page accessed with a web browser, mobile device application, or any application or software residing on a computing device.

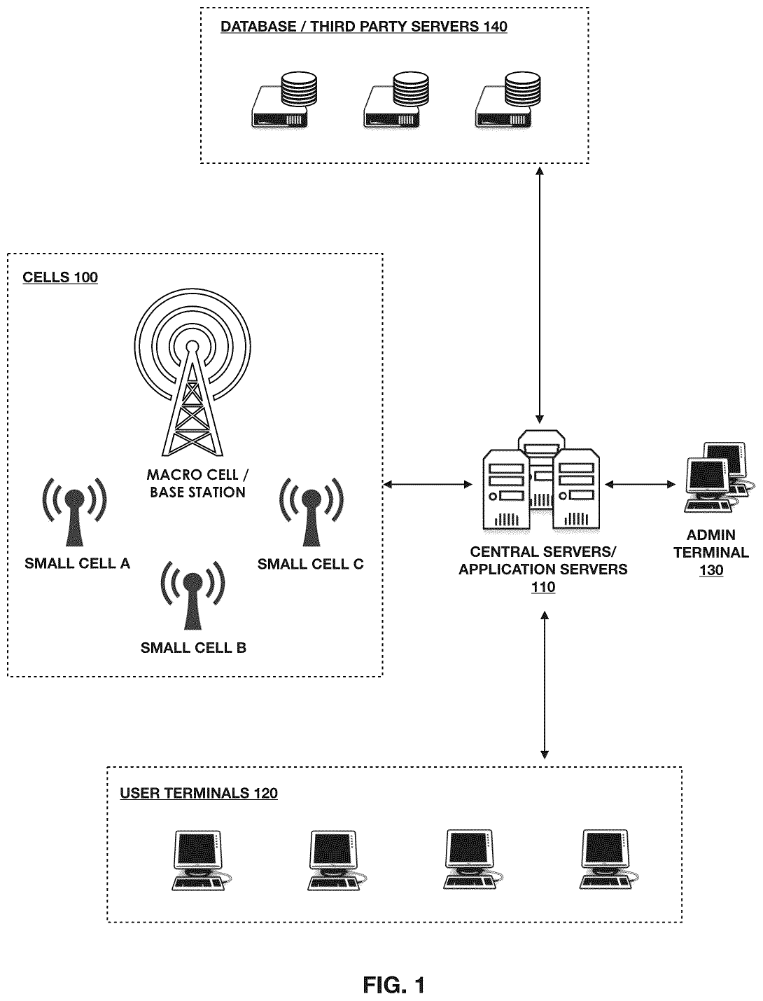

FIG. 1 illustrates one non-limiting exemplary embodiment of a general network architecture of the SCAP process, apparatus, computer-readable medium, and system of the disclosure described herein. In particular, cells 100 can be in bi-directional communication over a network with central servers, databases, or application servers 110 of the disclosure described herein. In particular, cells 100 can include any number of macro-cells, base transceivers, base stations, and small cells or nodes. For example, it is contemplated within the scope of the present disclosure described herein that there may be any number of macro-cells that communicate with each other and/or with their corresponding small cells to improve and expand cellular and wireless network coverage, reliability, throughput, and quality of the macro-cells or the network provider within a given geographical region or area. It is also contemplated within the scope of the present disclosure described herein that any of cells 100, including macro-cells and small cells and any variations thereof, such as femtocells, picocells, and microcells, may be referred to herein as cells. As shown herein, for exemplary purposes, small cells A, B, and C may be in communication with a central or main macro-cell (or multiple macro-cells) or base station tower network.

Still referring to FIG. 1, one or more user terminals 120 can also be in bi-directional communication over a network with central servers 110. Specifically, central servers 110 can receive and process user requests with respect to an SCAP engine and algorithm of the disclosure described herein and further report and present the results to each user terminal 120. Here, each user terminal 120 may further access and view the GUI portal and map with respect to the SCAP process and system of the disclosure described herein. In addition, an admin terminal 130 may also be in bi-directional communication with central servers 110 to manage and monitor various types of network data, known performance indicators (“KPIs”), credentials, user privileges, and the like. Further, the SCAP process and system of the disclosure described herein may also include one or more databases and third-party servers 140 in bi-directional communication over a network with central servers 110. Here, servers 140 can provide various types of data storage, data streams, data feeds, and/or provide various types of third-party support services to central servers 110. However, it is contemplated within the scope of the present disclosure described herein that the SCAP process and system of the disclosure described herein can include any type of general network architecture.

Still referring to FIG. 1, one or more of servers and terminals 110-140 may include a personal computer (PC), a printed circuit board comprising a computing device, a mini-computer, a mainframe computer, a microcomputer, a telephonic computing device, a wired/wireless computing device (e.g., a smartphone, a personal digital assistant (PDA)), a laptop, a tablet, a smart device, a wearable device, or any other similar functioning device.

In some embodiments, as shown in FIG. 1, one or more servers and terminals 110-140 may include a set of components, such as a processor, a memory, a storage component, an input component, an output component, a communication interface, and a JSON UI rendering component. The set of components of the device may be communicatively coupled via a bus.

The bus may comprise one or more components that permit communication among the set of components of one or more of servers and terminals 110-140. For example, the bus may be a communication bus, a cross-over bar, a network, or the like. The bus may be implemented using single or multiple (two or more) connections between the set of components of one or more of servers and terminals 110-140. The disclosure is not limited in this regard.

One or more of servers and terminals 110-140 may comprise one or more processors. The one or more processors may be implemented in hardware, firmware, and/or a combination of hardware and software. For example, the one or more processors may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The one or more processors also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The one or more processors may control overall operation of one or more of servers and terminals 110-140 and/or of the set of components of one or more of servers and terminals 110-140 (e.g., memory, storage component, input component, output component, communication interface, rendering component).

One or more of servers and terminals 110-140 may further comprise memory. In some embodiments, the memory may comprise a random access memory (RAM), a read only memory (ROM), an electrically erasable programmable ROM (EEPROM), a flash memory, a magnetic memory, an optical memory, and/or another type of dynamic or static storage device. The memory may store information and/or instructions for use (e.g., execution) by the processor.

A storage component of one or more of servers and terminals 110-140 may store information and/or computer-readable instructions and/or code related to the operation and use of one or more of servers and terminals 110-140. For example, the storage component may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

One or more of servers and terminals 110-140 may further comprise an input component. The input component may include one or more components that permit one or more of servers and terminals 110-140 to receive information, such as via user input (e.g., a touch screen, a keyboard, a keypad, a mouse, a stylus, a button, a switch, a microphone, a camera, and the like). Alternatively or additionally, the input component may include a sensor for sensing information (e.g., a global positioning system (GPS) component, an accelerometer, a gyroscope, an actuator, and the like).

An output component any one or more of servers and terminals 110-140 may include one or more components that may provide output information from the device 100 (e.g., a display, a liquid crystal display (LCD), light-emitting diodes (LEDs), organic light emitting diodes (OLEDs), a haptic feedback device, a speaker, and the like).

One or more of servers and terminals 110-140 may further comprise a communication interface. The communication interface may include a receiver component, a transmitter component, and/or a transceiver component. The communication interface may enable one or more of servers and terminals 110-140 to establish connections and/or transfer communications with other devices (e.g., a server, another device). The communications may be effected via a wired connection, a wireless connection, or a combination of wired and wireless connections. The communication interface may permit one or more of servers and terminals 110-140 to receive information from another device and/or provide information to another device. In some embodiments, the communication interface may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface may provide for communications with another device via a device-to-device (D2D) communication link, such as FlashLinQ, WiMedia, Bluetooth, ZigBee, Wi-Fi, LTE, 5G, and the like. In other embodiments, the communication interface may include an Ethernet interface, an optical interface, a coaxial interface, an infrared interface, a radio frequency (RF) interface, or the like.

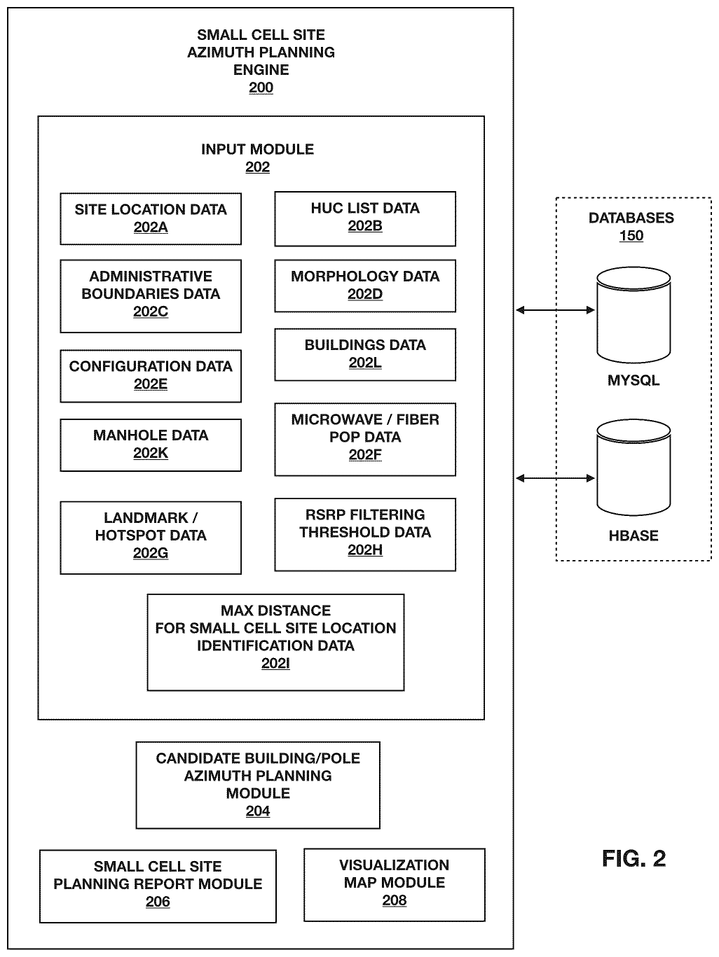

FIG. 2 illustrates one non-limiting exemplary embodiment of the SCAP engine, algorithm, apparatus, system components and modules of the disclosure described herein. Here, SCAP engine 200 can include an input module 202 configured to provide input data and parameters to the SCAP engine 200 and algorithm disclosed herein. Here, input module 202 can further include sub-module input parameters or components for site location data 202A, highly utilized cell sample list (“HUC”) data 202B, administrative boundaries data 202C, morphology data 202D, configuration data 202E, microwave and fiber point of presence (“PoP”) data 202F, landmark and hotspot data 202G, reference signal received power (“RSRP”) filtering threshold data 202H, max distance for small cell site location identification data 2021, manhole data 202K, and buildings data 202L.

Still referring to FIG. 2, any of the input sub-modules 202A-202L can retrieve data therefrom or store data thereto databases 150, which can include among others, one or more MySQL databases, Hbase, or any other type of relational database management system (“RDBMS”). In particular, site location data module 202A can retrieve and receive input with respect to one or more or all sites and locations within a selected network, including site data such as latitude, longitude, azimuth, band details, extended cell global identification (“ECGI”) antenna height, and electrical tilt, among others, to be used by the SCAP engine 200. The HUC list data 202B can include a list of the HUC samples within a pre-defined or user defined period of time to be used by SCAP engine 200. As used herein, an HUC can be any cell macro-cell, small cell, or otherwise, preferably a macro-cell or base station, that is highly utilized within a network, has above average utilization or traffic or congestion within a network, has a degree of utilization or congestion that is above a pre-defined utilization or congestion parameter, or has a degree of utilization or congestion that meets or is above an industry recognized standard with respect to network cell utilization. Further, any type of algorithm, engine, process, or application may be used to identify the HUCs within the list with respect sub-module 202B.

Still referring to FIG. 2, administrative boundaries data sub-module 202C can include various geographical boundaries to be used by the SCAP engine 200. Morphology sub-module 202D can include various geographic area morphologies (e.g., dense urban, sub urban, urban, rural, etc.) and building data sub-module 202L can include various building and structure data (e.g., location, size, height, etc.) to be used by the SCAP engine 200, wherein modules 202D and 202L can each receive data from different data sources. Configuration data sub-module 202E can include various types of configuration data within a network to be used by the SCAP engine 200. Microwave and Fiber PoP or fiber-optic network data sub-module 202F can include site and location related information pertaining to fiber PoPs/fiber-optics to be used by the SCAP engine 200, including microwave data, XPIC site data, microwave links, and microwave radio transmission. Manhole data sub-module 202K can include various types of information, including location information, pertaining to manholes or manhole covers having antennas for signal propagation. Landmark and hotspot data sub-module 202G can include various site related location data pertaining to various types of city or regional landmark sites and known wireless hotspot sites to be used by the SCAP engine 200. Here, parameters pertaining to any of sub-modules 202A-202L may be pre-defined and retrieved from databases 100. However, it is contemplated within the scope of the present disclosure described herein that any of the data pertaining to sub-modules 202A-202L may also be user defined and configurable.

Still referring to FIG. 2, RSRP filtering threshold data sub-module 202H can provide configurable and user defined input parameters. In particular, in one exemplary embodiment, RSRP filtering threshold or condition can be configured, defined, predefined, or set to be less than −95 dBm or (<−95 dBm) or less than or equal to −95 dBm (<=−95 dBm) to be used by the SCAP engine 200. However, it is contemplated within the scope of the present disclosure described herein that the RSRP filtering threshold can be set to any suitable value depending on the desired output of the SCAP engine and other network parameters, variables, and constraints. Maximum distance to small cell site location identification data sub-module 202I can allow the user to configure, define, or set a maximum distance for a small cell site location based on a calculated cell range or defined value for a particular morphology. TABLE 1 illustrates exemplary data for various types of morphologies and their associated maximum distances (which can be fixed values) which can further be used by the SCAP engine 200. With respect to one embodiment of the disclosure described herein, a distance for potential candidate small cell site locations with respect to planned or on-air macro cells can be configured at 156 m, wherein such candidate small cells fall can within or less than the 156 m distance of the planned or on-air macro cells.

TABLE 1

| MORPHOLOGY | DISTANCE | |
|---|---|---|
| Dense Urban | 500 | m |
| Sub Urban | 1250 | m |
| Urban | 800 | m |
| Rural | 800 | m |

Still referring to FIG. 2, the SCAP engine 200 can also include a candidate building and pole azimuth planning module 204 that can use any one or more of the input parameters within input module 202 and its associated sub-modules 202A-202L in order to identify candidate buildings and poles and suggested azimuths for small cell site deployment, which will be discussed later in this disclosure in more detail. In addition, SCAP engine 200 can also include a small cell site report planning module 206 that can output the results of the candidate small cell site locations and azimuths to the user. In addition, SCAP engine 200 can also include a visualization map module 208 that can output and visually display via a GUI portal the identified candidate small cell site locations and their azimuths.

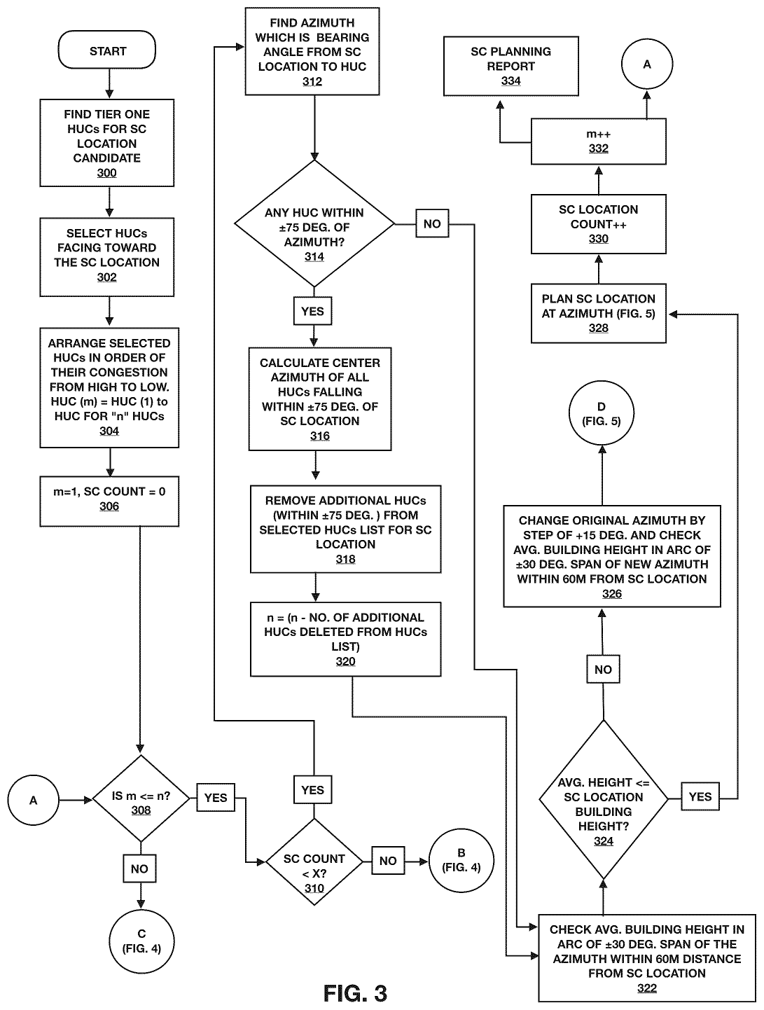

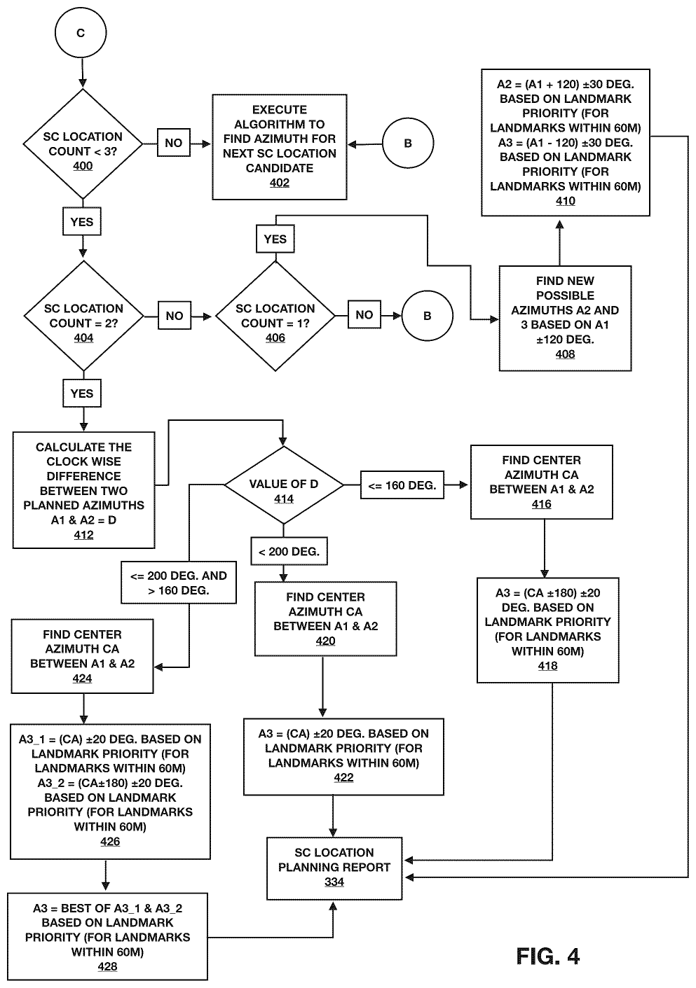

FIG. 3 illustrates one non-limiting exemplary embodiment of a process flow for the SCAP engine 200, algorithm, system, apparatus, and method of the disclosure described herein. Here, the process can begin at step 300, wherein a list of any one or more or all tier one HUCs for identified small cell (“SC”) location candidates, such as outdoor small cell sites, within a network are retrieved/received and compiled. In one embodiment, the list can be of geolocated or geotagged samples of HUCs as of the first day of the month. In particular, each HUC can be separated by their classes, such as HUCs within Class 1, Class 2, or Class 3, among others, based on the number of HUCs at a site. For example, a Class 3 site is any site having multiple cells, such as three sectors, wherein Class 3 is more highly congested than Class 2. Class 2 sites can be any site having two sectors, wherein Class 2 is more congested than Class 1, and Class 1 can be any site having one sector. At step 302, the process can select the tier one HUCs (such as their radio transmitters, receivers, or transceivers) geographically oriented towards or facing toward their identified small cell site locations (such as their radio transmitters, receivers, or transceivers), which are HUCs that have an azimuth within a ±45 degree of bearing angle to the SC site location or radio. Here, a first radio can be the HUC and a second radio can be the SC and if both radios fall within 45 degrees of each other than those respective HUCs are used in the process and the other discarded. At step 304, the process can arrange the selected HUCs in order of their network congestion, such as from high congestion to low congestion, which can be represented by the following formula: HUC(m)=HUC(1) to HUC for n number of HUCs. At step 306, the process can set the following initial conditions for the foregoing formula, namely: m=1, SC count=0. At step 308, the process can determine whether m is less than or equal to n, and if no, the process can move step C (which is continued on FIG. 4), and if yes, then the process can proceed to step 310. Still referring to step 308, the process can also receive the output of step A as it's input. At step 310, the process can determine wither the SC count is less than x (which can be any predefined value), and if no, the process can move to step B (which is continued FIG. 4), and yes, then process can proceed to step 312.

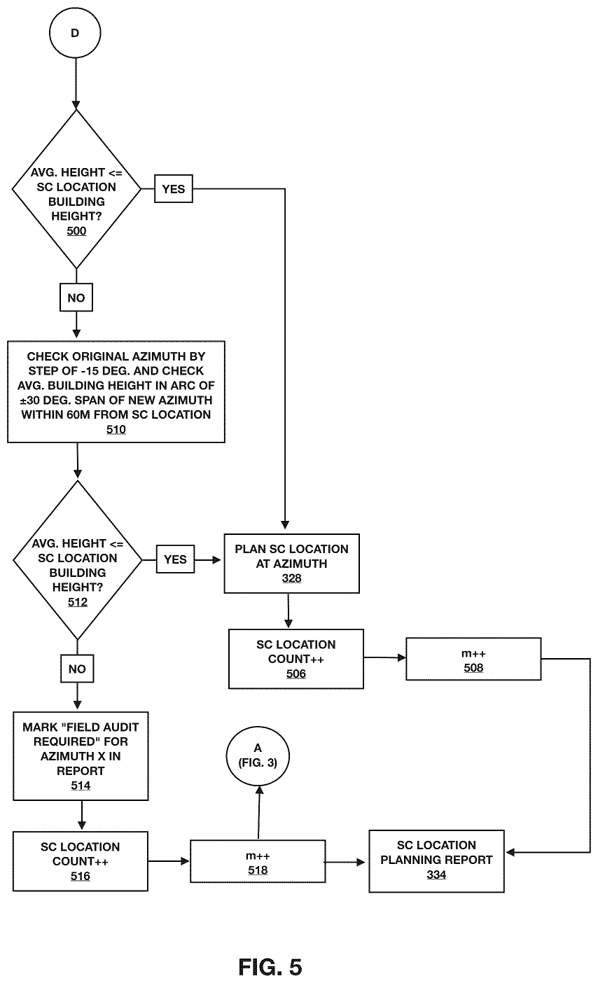

Still referring to FIG. 3, at step 312, the process can find azimuth (A), which is generally the angle from an SC location to an HUC(m). At step 314, the process can determine whether any HUCs fall within a ±75 degree of azimuth (A) with respect to an SC location. If no, then the process can move to step 322, which will be discussed later in detail, and if yes, then the process can move to step 316. At step 316, the process can calculate a center azimuth for HUCs falling within ±75 degree azimuth (A) of an SC location. At step 318, the process can remove the additional HUCs within a ±75 degree azimuth (A) from the selected HUC list for the SC location. At step 320, the process can assign n=(n−number of additional HUCs removed from HUC list) where n is the number of HUCs identified at the start of the process. At step 322 (which can also continue from step 314), the process can check average building height in an arc having a ±30 degree span of azimuth(A) within a 60 m distance from an SC location. At step 324, the process can determine whether the average building height is less than or equal to an identified SC location building height. If no, then the process can proceed to step 326, and if yes, then the process can proceed to step 328. At step 326, the process can change the original azimuth(A) by a step of +15 degrees and check the average building height in the arc having ±30 degree of a new azimuth A1 within 60 m distance, and the process can then move to step D (which is continued in FIG. 5).

Still referring to FIG. 3, at step 328, the process can plan a SC location at the new azimuth A1 determined at step 326. At step 330, the process can perform SC location count++ (i.e., post increment/use the value of count first, then increment it by one) and at step 332 the process can perform m++ (i.e., post increment/use the value of count first, then increment it by one). Here, since the new azimuth A1 has been calculated for a first sector row, then count++can refer to calculating another azimuth for a second sector row and incrementing the SC location. Further, since m refers to the number of HUC cells, and some HUCs have been offloaded since the finding of the new azimuth, then m++ can refer to moving on to the next HUC by incrementing m. Here, the output of step 332 can move to step A which is provided as input in step 308. In addition, at step 332, the process can send the output with respect to the azimuths to an SC planning report module at step 334. In particular, the SC planning report can include a table or GUI visualization having categories such as a geographic area (such as state), identification (“ID”) for the geographic area, cluster ID, SC location ID, SC location candidate azimuth x (in degrees) or A1, SC location candidate azimuth y (in degrees) or A2, and SC location candidate azimuth z (in degrees) or A3.

FIG. 4 illustrates one non-limiting exemplary embodiment of a process flow for the SCAP engine 200, which is a continuation from FIG. 3. Here, the process can continue from step C of FIG. 3 at step 400. In particular, at step 400, the process can determine whether the SC location count is less than three (3), and if no, then the process can proceed to step 402 in order to execute the algorithm of the SCAP engine to find the azimuth for the next SC location candidate (which can also receive as input the output of step B), and if yes, then the process can proceed to step 404. At step 404, the process can determine whether the SC location count is equal to two (2), and if no, then the process can proceed to step 406, and if yes, then the process can proceed to step 412. At step 406, the process can further determine whether the SC location count is equal to one (1), and if no, then the process can proceed to step B, and if yes, then the process can proceed to step 408. At step 408, the process can find new potential or possible azimuths, namely, azimuth A2 and A3, based on within ±120 degrees of center azimuth A1. Next, the process can proceed to step 410, wherein A2=(A1+120)+30 degrees based on landmark priority (for landmarks within 60 m), and A3=(A1−120)+30 degrees based on landmark priority (for landmarks within 60 m). The process can then proceed to step 334, wherein the output of step 410 is provided as input into the SC location planning report for suggested azimuths of SC locations (such as the SC radio transmitters, receivers, or transceivers), including azimuths A1, A2, and A3. Here, landmark priority can refer to a landmark that is defined by a user or network vendor to be of high importance or priority.

Still referring to FIG. 4, at step 412, the process can calculate a clock-wise difference between two planned or suggested azimuths A1 and A2 being set to equal D. At step 414, the process can determine whether the value of D is less than or equal to 160 degrees, less than 200 degrees, or less than or equal to 200 degrees and greater than 160 degrees. If D is less than or equal to 160 degrees, then the process can proceed to step 416. At step 416, the process can find center azimuth CA between azimuths A1 and A2. At step 418, the process can set A3=(CA+180)+20 degrees based on landmark priority (for landmarks within 60 m). Next, the process can then proceed to step 334, wherein the output of step 418 is provided as input into the SC location planning report for suggested azimuths of SC locations. Referring back to step 414, if the value of D is less than 200 degrees, then the process can proceed to step 420. At step 420, the process can find a center azimuth CA between azimuths A1 and A2. At step 422, the process can set A3=(CA)+20 degrees based on landmark priority (for landmarks within 60 m). Next, the process can then proceed to step 334, wherein the output of step 422 is provided as input into the SC location planning report for suggested azimuths of SC locations. Referring back to step 414, if the value of D is less than or equal to 200 degrees and greater than 160 degrees, then the process can proceed to step 424. At step 424, the process can find center azimuth CA between azimuths A1 and A2. Next, at step 426, the process can set A3_1=(CA)+20 degrees based on landmark priority (for landmarks within 60 m) and A3_2=(CA+180)+20 degrees based on landmark priority (for landmarks within 60 m). At step 428, the process can determine azimuth A3 based on the best of A3_1 and A3_2 having the best landmark priority (for landmarks within 60 m). Next, the process can then proceed to step 334, wherein the output of step 428 is provided as input into the SC location planning report for suggested azimuths of SC locations.

FIG. 5 illustrates one non-limiting exemplary embodiment of a process flow for the SCAP engine 200, which is also a continuation from FIG. 3. At step 500, the process receives as input the output of step D. In particular, at step 500, the process can determine if the average building height is less than or equal to the SC location building height, and if no, then the process can proceed to step 510, and if yes, then the process can proceed to step 328. At step 328, the process can plan the SC location at the new azimuth A1, and move to step 506 wherein a count++ operation is applied, and step 508, wherein a m++ operation is applied, and finally wherein the output of step 508 is received as input into the SC location planning report of step 334, wherein the suggested azimuths of the SC locations for all sectors are provided as output. At step 510, the process can check the original azimuth by a step of −15 degrees and check the average building height in an arc of a+30 degree span of a new azimuth within 60 m from SC location. Next, at step 512, the process can determine whether the average building height is less than the SC location building height, and if no, then the process can proceed to step 514, and if yes, then the process can proceed to step 328. At step 328, the process can plan the SC location at the azimuth, and move to step 506 wherein a count++ operation is applied, and step 508, wherein a m++ operation is applied, and finally wherein the output of step 508 is received as input into the SC location planning report of step 334, wherein the suggested azimuths of the SC locations for all sectors are provided as output. At step 514, the process can provide a notification, annotation, or mark, such as “Field Audit Required,” for azimuth x in the SC location planning report, and further apply an SC location count++ operation at step 516, followed by a m++ operation at step 518, wherein the output can be sent back to step A (FIG. 3) for further processing and the SC planning report at step 334.

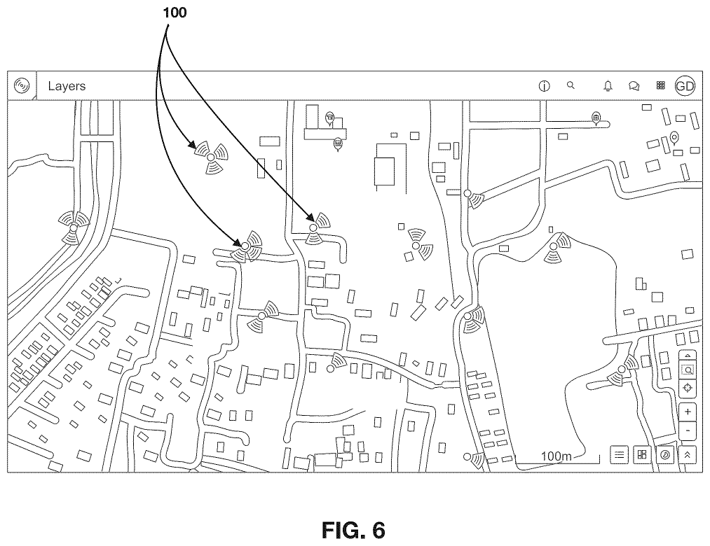

FIG. 6 illustrates one non-limiting exemplary embodiment of cells 100 (such as the identified small cell site locations with their planned or suggested azimuths) displayed with respect to their identified site locations via the foregoing SCAP engine, process, apparatus, and system of the disclosure described herein on a Graphical Information System (“GIS”) or GUI portal map view. Specifically, identified cells 100 on the map of FIG. 6 can represent candidate outdoor spaces, structures, or buildings for which small cells can be deployed by a radio access network provider.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method of determining one or more azimuths for identified cell site locations within a cellular network, the method comprising:
receiving a list of one or more first cells with respect to a network;
selecting from the list one or more first cells that are geographically oriented towards a second cell;
arranging the selected one or more first cells based on their network congestion;
calculating a first azimuth between the second cell and at least one of the arranged one or more first cells; and
determining that at least one of the one or more first cells is within a first predefined range of the first azimuth.

2. The method of claim 1, further comprising:
upon determining that at least one of the one or more first cells is within a first predefined range of the first azimuth, calculating a second azimuth for the one or more first cells within the first predefined range with respect to the second cell.

3. The method of claim 2, further comprising:
determining if an average structure height is within a second predefined range of the first azimuth;
determining if the average structure height is less than or equal to a structure height of the second cell; and
upon determining that the average structure height is within the second predefined range of the first azimuth and the average structure height is less than or equal to a structure height of the second cell, suggesting a location for the second cell at the first azimuth.

4. The method of claim 1, further comprising:
upon determining that at least one of the one or more first cells is not within a first predefined range of the first azimuth, determining if an average structure height is within a second predefined range of the first azimuth;
determining if the average structure height is less than or equal to a structure height of the second cell; and
upon determining that the average structure height is within the second predefined range of the first azimuth and the average structure height is less than or equal to a structure height of the second cell, suggesting a location for the second cell at the first azimuth.

5. The method of claim 1, further comprising:
determining if an average structure height is within a second predefined range of the first azimuth;
determining if the average structure height is less than or equal to a structure height of the second cell; and
upon determining that the average structure height is within the second predefined range of the first azimuth and the average structure height is not less than or equal to a structure height of the second cell, modifying the first azimuth via a first step and determining if the average structure height is within the second predefined range of the modified first azimuth by the first step.

6. The method of claim 5, further comprising:
determining, after the determined modified first azimuth by the first step, if the average structure height is less than or equal to the structure height of the second cell; and
upon determining that the average structure height is less than or equal to the structure height of the second cell, suggesting a location for the second cell at the modified first azimuth by the first step.

7. The method of claim 5, further comprising:
determining, after the determined modified first azimuth, if the average structure height is less than or equal to the structure height of the second; and
upon determining that the average structure height is not less than or equal to the structure height of the second cell, modifying the first azimuth by a second step and determining if the average structure height is within the second predefined range of the modified first azimuth by the second step.

8. The method of claim 7, further comprising:
determining, after the determined modified first azimuth by the second step, if the average structure height is less than or equal to the structure height of the second cell; and
upon determining that the average structure height is less than or equal to the structure height of the second cell, suggesting a location for the second cell at the modified first azimuth by the second step.

9. The method of claim of 8, further comprising:
determining, after the determined modified first azimuth by the second step, if the average structure height is less than or equal to the structure height of the second cell; and
upon determining that the average structure height is not less than or equal to the structure height of the second cell, providing a notification.

10. The method of claim 1, further comprising:
determining if the second cell meets a first or second criteria with respect to the number of second cell locations;
upon determining that the second cell meets the first or second criteria; and
determining a second and third azimuth for the second cell.

11. An apparatus for determining one or more azimuths for identified cell site locations within a cellular network, comprising:
a memory storage storing computer-executable instructions; and
a processor communicatively coupled to the memory storage, wherein the processor is configured to execute the computer-executable instructions and cause the apparatus to:
receive a list of one or more first cells with respect to a network;
select from the list one or more first cells that are geographically oriented towards a second cell;
arrange the selected one or more first cells based on their network congestion;
calculate a first azimuth between the second cell and at least one of the arranged one or more first cells; and
determine that at least one of the one or more first cells is within a first predefined range of the first azimuth.

12. The apparatus of claim 11, wherein the computer-executable instructions, when executed by the processor, further cause the apparatus to:
upon determining that at least one of the one or more first cells is within a first predefined range of the first azimuth, calculate a second azimuth for the one or more first cells within the first predefined range with respect to the second cell.

13. The apparatus of claim 12, wherein the computer-executable instructions, when executed by the processor, further cause the apparatus to:
determine if an average structure height is within a second predefined range of the first azimuth;
determine if the average structure height is less than or equal to a structure height of the second cell; and
upon determining that the average structure height is within the second predefined range of the first azimuth and the average structure height is less than or equal to a structure height of the second cell, suggest a location for the second cell at the first azimuth.

14. The apparatus of claim 11, wherein the computer-executable instructions, when executed by the processor, further cause the apparatus to:
upon determining that at least one of the one or more first cells is not within a first predefined range of the first azimuth, determine if an average structure height is within a second predefined range of the first azimuth;
determine if the average structure height is less than or equal to a structure height of the second cell; and
upon determining that the average structure height is within the second predefined range of the first azimuth and the average structure height is less than or equal to a structure height of the second cell, suggest a location for the second cell at the first azimuth.

15. The apparatus of claim 11, wherein the computer-executable instructions, when executed by the processor, further cause the apparatus to:
determine if an average structure height is within a second predefined range of the first azimuth;
determine if the average structure height is less than or equal to a structure height of the second cell; and
upon determining that the average structure height is within the second predefined range of the first azimuth and the average structure height is not less than or equal to a structure height of the second cell, modify the first azimuth via a first step and determining if the average structure height is within the second predefined range of the modified first azimuth by the first step.

16. The apparatus of claim 15, wherein the computer-executable instructions, when executed by the processor, further cause the apparatus to:
determine, after the determined modified first azimuth by the first step, if the average structure height is less than or equal to the structure height of the second cell; and
upon determining that the average structure height is less than or equal to the structure height of the second cell, suggest a location for the second cell at the modified first azimuth by the first step.

17. The apparatus of claim 15, wherein the computer-executable instructions, when executed by the processor, further cause the apparatus to:
determine, after the determined modified first azimuth by the first step, if the average structure height is less than or equal to the structure height of the second cell; and
upon determining that the average structure height is not less than or equal to the structure height of the second cell, modifying the first azimuth by the first step via a second step and determining if the average structure height is within the second predefined range of the modified first azimuth by the second step.

18. The apparatus of claim 17, wherein the computer-executable instructions, when executed by the processor, further cause the apparatus to:
determine, after the determined modified first azimuth by the second step, if the average structure height is less than or equal to the structure height of the second cell; and
upon determining that the average structure height is less than or equal to the structure height of the second cell, suggest a location for the second cell at the modified first azimuth by the second step.

19. The apparatus of claim of 18, wherein the computer-executable instructions, when executed by the processor, further cause the apparatus to:
determine, after the determined modified first azimuth by the second step, if the average structure height is less than or equal to the structure height of the second cell; and
upon determining that the average structure height is not less than or equal to the structure height of the second cell, provide a notification.

20. A non-transitory computer-readable medium comprising computer-executable instructions for determining one or more azimuths for identified cell site locations within a cellular network by an apparatus, wherein the computer-executable instructions, when executed by at least one processor of the apparatus, cause the apparatus to:
receive a list of one or more first cells with respect to a network;
select from the list one or more first cells that are geographically oriented towards a second cell;
arrange the selected one or more first cells based on their network congestion;
calculate a first azimuth between the second cell and at least one of the arranged one or more first cells; and
determine that at least one of the one or more first cells is within a first predefined range of the first azimuth.
